(19) United States
(12) Patent Application Publication
(10) Pub. No.: US 2015/0331934 A1
(43) Pub. Date: Nov. 19, 2015

(54) Search and Execute: Electronic Commerce Transactions and Messaging from the Search Bar

(71) Applicant: Adeel Arif, Bensalem, PA (US)

(72) Inventor: Adeel Arif, Bensalem, PA (US)

(73) Assignee: KOOBECAFE, LLC, Lansdale, PA (US)

(21) Appl. No.: 14/713,925

(22) Filed: May 15, 2015

Related U.S. Application Data
(60) Provisional application No. 61/993,535, filed on May 15, 2014.

(51) Int. Cl. G06F 17/30; G06F 17/27; G06F 17/24

(52) U.S. Cl. CPC G06F 17/30643; G06F 17/243; G06F 17/2735

(57) ABSTRACT

In one embodiment, a computer-implemented method for extending functionality of a browser text-entry field, e.g., via a browser add-on or extension. The method includes: (a) the computer monitoring the browser text-entry field to detect a predetermined initial combination of characters in a query entered by a user; and (b) if the predetermined initial combination of characters is detected in the query, then: (i) the computer detecting the remaining characters in the query; and (ii) the computer providing, to a software routine, the remaining characters in the query. The software routine is selected based on the initial combination of characters and may be a messaging routine that sends a message to an identified user or user account (e.g., SMS, phone call, social media), or an electronic commerce routine that sends identification of one or more offerings to the identified merchant or merchant account to initiate a purchase.

### CROSS-REFERENCE TO RELATED APPLICATION

This application claims priority to co-pending U.S. Provisional Patent Application Ser. No. 61/993,535, filed May 15, 2014, the disclosure of which is incorporated herein by reference in its entirety.

### FIELD OF THE DISCLOSURE

The present disclosure relates generally to electronic commerce, and, in particular, to conducting electronic commerce via a web browser.

### BACKGROUND

The Internet today comprises billions of computers, tablets and mobile devices connected to each other via a plurality of distributed interconnected networks over HTTP/HTTPS. These interconnected devices exchange information and perform electronic transactions through web services hosted on a server system. A search engine not only serves as a directory for these services but also has become a starting point for performing additional functionality to access resources on the web. For example, search engine users are using a search engine's search bar (e.g., as may be implemented in a toolbar of a browser or an input field on a web page) as their calculator and spell checker. However, such functionality is still relatively limited.

### SUMMARY OF THE INVENTION

In one embodiment, the present invention provides a computer-implemented method for extending functionality of a browser text-entry field. The method includes: (a) the computer monitoring the browser text-entry field to detect a predetermined initial combination of characters in a query entered by a user; and, (b) if the predetermined initial combination of characters is detected in the query, then: (i) the computer detecting the remaining characters in the query; and (ii) the computer providing, to a software routine, the remaining characters in the query.

In another embodiment, the present invention provides a system for extending functionality of a browser text-entry field. The system includes a processor adapted to: (a) monitor the browser text-entry field to detect a predetermined initial combination of characters in a query entered by a user; and, (b) if the predetermined initial combination of characters is detected in the query, then: (i) detect the remaining characters in the query; and (ii) provide, to the software routine, the remaining characters in the query.

The software routine is selected based on the initial combination of characters and may be a messaging routine that sends a message to an identified user or user account (e.g., SMS, phone call, social media), or an electronic commerce routine that sends identification of one or more offerings to the identified merchant or merchant account to initiate a purchase.

### BRIEF DESCRIPTION OF THE DRAWINGS

FIG. 1 is a flowchart showing an exemplary workflow for search-based messaging and electronic commerce transactions, in one embodiment of the invention;

FIG. 2 shows screen views that collectively illustrate a process for performing an electronic commerce transaction directly from the search bar, in one embodiment of the invention; and

FIG. 3 shows screen views that collectively illustrate a process for performing an electronic commerce transaction using voice input, in one embodiment of the invention.

### DETAILED DESCRIPTION

The following description is presented to enable any person skilled in the art to make and use the invention, and is provided in the context of particular applications of the invention and their requirements. Various modifications to the disclosed embodiments will be readily apparent to those skilled in the art, and the general principles defined herein may be applied to other embodiments and applications without departing from the scope of the present invention. Thus, the present invention is not intended to be limited to the embodiments shown, but is to be accorded the widest scope consistent with the principles and features disclosed herein.

It has become desirable to allow users to perform more and more functions directly from the search bar. Embodiments of the invention provide methods for allowing users to perform electronic commerce transactions and to send messages to other users of the system directly from the search bar (or browser bar, or similar text-entry field used for entering URLs and/or search terms into a browser, irrespective of whether the text-entry field is part of the browser itself, on a web page displayed by the browser, or in a browser toolbar or other add-on module to a browser).

The present invention provides a method and a system for facilitating an electronic communication between two parties, server systems or web services directly from the search box or search bar of a search engine, such as Google, Yahoo, Bing, etc. Communication is enabled via a Browser Add-on Application Module (BAAM) that listens for a special combination of characters to be entered or typed into a search bar (or browser bar, or similar text-entry field used for entering URLs and/or search terms into a browser). When the combination matches a predetermined pattern, the BAAM intercepts the message and re-routes it to the correct party (e.g., an email recipient or an e-commerce server) using a back-end server system. In one embodiment, the BAAM and the server system are integrated into the search engine, hence eliminating the need to for the user to manually install and run a browser add-on application. In another embodiment, the BAAM and the server system are independently run and managed by a third party.

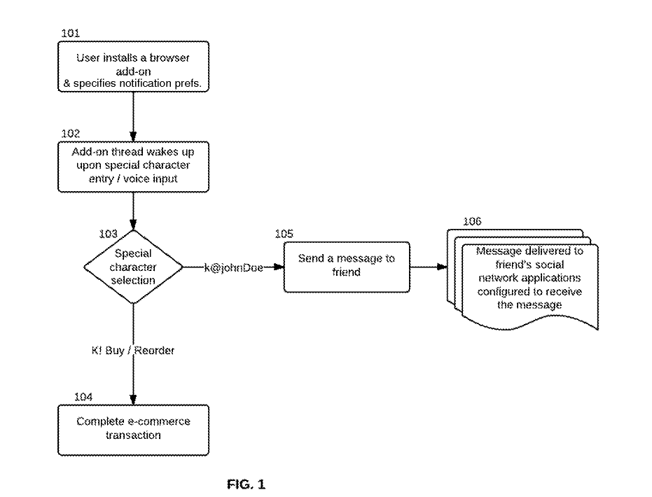

FIG. 1 illustrates an exemplary user work flow of an application that implements a method consistent with one embodiment of the invention. In the case of a search engine that does not have such a method integrated into its core functionality, the user can enable such functionality by installing a browser add-on application/extension. The browser add-on application module (BAAM) extends the functionality of the search bar beyond searching, by enabling users to take advantage of additional features provided through the system described herein. The BAAM runs in the background and listens for special characters that are associated with features offered. When there is a match, an application thread wakes up and intercepts the query and directs it to the requested resource. In one embodiment, the special character combination “K!” is used for an electronic commerce transaction, and the special character combination “K@” is used for messaging between two users. However, other special character combinations may be programmed into the system and may be user-configurable, so that the selected special character combinations can be modified easily to suit a given business or functionality.

In the example illustrated in FIG. 1, the user sends a message to a friend using the special character combination k@<username>. For instance, entering “k@johndoe want to meet for lunch?” into the search bar will send a message to user John Doe using one or more messaging applications that John Doe has configured to be used for this kind of messaging.

First, at step 101, the user installs the BAAM add-on into his or her browser and sets up an account. During that process, the user is asked to specify notification and messaging preferences, for example, by e-mail, by text message, by mobile phone, by social media platform, and so forth. At step 102, the BAAM monitors the search bar until one of the special character combinations “k@” and “K!” is detected. Once this special character combination has been detected, the BAAM thread wakes up and intercepts and sends the search engine query to its back-end server system. At step 103, a determination is made whether the combination “k@” or the combination “K!” is present. If the combination “k@” is detected, then the server system checks to see if the user name “johndoe” is valid. Upon validation, at step 105, the server system sends the message to the user on a platform where the user is active, or a platform that the user has configured during step 101 to receive messages from the search engine. If the user happens to be active on a social network, such as Google Hangouts, then, at step 106, the message is sent directly to the social network. If the user has opted-in to receive messages as text messages on his or her cell phone, then the message is sent directly to the cell phone. The user can configure multiple options for message delivery when setting up his or her account. A message can be broadcasted to all messaging applications, the application where user is active, or a combination of the two, depending on user preference. Messages can be delivered using a conventional message queue, exchange, and buffer arrangement, which can be implemented in any programming language. If, at step 103, the combination “k@” is detected, then, at step 104, the server system initiates and allows the user to complete an e-commerce transaction.

In one embodiment, the following pseudocode may be used to implement a process for extending functionality of a browser search bar:

```
module browser_add_on_application_module( )
    call installation_routine
    call add-on_or_extension
end module
module installation_routine( )
    call install_add-on_or_extension
    call configure_messaging_and_notification_preferences
end module
module add-on_or_extension( )
    detect initial_characters in browser search bar
    do while initial_characters < > special_character_combination_1 and
initial_characters < > special_character_combination_2
        detect initial_characters in browser search bar
        if initial_characters = special_character_combination_1 then
            intercept entire query from browser
            detect remaining_characters in browser search bar
            call initiate_e-commerce_transaction(remaining_characters)
        else if initial characters = special_character_combination_2 then
            intercept entire query from browser
            detect remaining_characters in browser search bar
            call initiate_messaging(remaining_characters)
        end if
    end do
end module
module initiate_e-commerce_transaction
if word_following_special_character_combination_1 is valid_merchant_name then
    send all_subsequent_remaining_characters to valid_merchant_name web site to
direct user to corresponding checkout or item page
end if
end module
module initiate_messaging
if word_following_special_character_combination_2 is valid_user_name then
    send all_subsequent_remaining_characters to valid_user_name via user-specified
messaging method
end if
end module
```

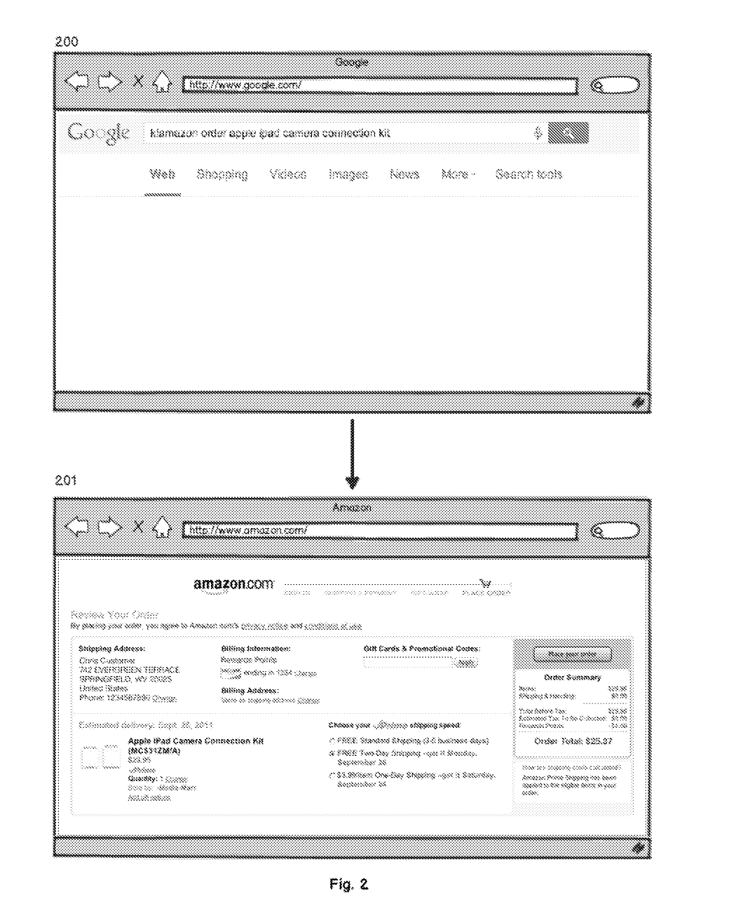

In one embodiment, this system can be used to complete an electronic commerce transaction, as illustrated in FIG. 2. For instance, as shown in screen view 200, the user types “K!amazon order ipad camera connection kit” into a search bar. The BAAM wakes up upon detecting the phrase “K! amazon” and intercepts and sends the query to its back-end server system. The server system interprets “K!amazon” as a request to place an order with the e-commerce web site Amazon.com. At that point, parameters of the query are passed to Amazon.com, and, if a one-click purchase option is available, then the user is directed straight to a checkout page, as shown in screen view 201. In the event a one-click purchase option is not available, or if additional user information is needed to complete the order, then Amazon.com can redirect the user to a product page with an option to complete the missing information. The e-commerce site Amazon.com is used herein merely as an example. The foregoing method and system may be used with the electronic commerce web site of any merchant and can be made available for integration via an Application Program Interface.

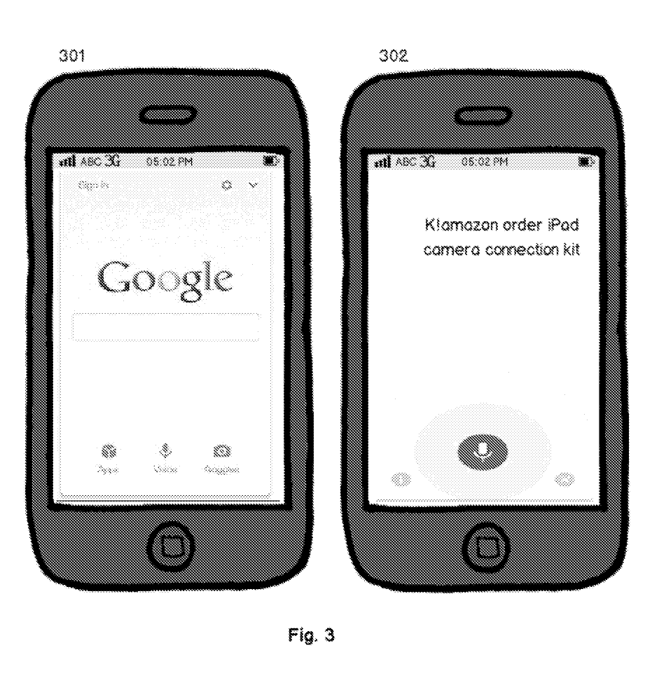

This system and method can be implemented using voice input, as illustrated in FIG. 3. In this scenario, the phrase “K@johndoe” (pronounced “kay at john doe”) would be interpreted just as if the user had typed k@johndoe into the search bar. The phrase “K!amazon” (pronounced “k bang amazon”) would result in the same action as if the user had typed “K!amazon” into the search bar. This voice-based input may be employed as a “social concierge,” thereby allowing a user to simply pick up the phone and ask to place an order or send a message to a friend, and the system then takes care of the rest using the workflow described above to implement the desired functionality.

Only exemplary embodiments of the present invention and a few examples of its versatility are shown and described in the present disclosure. It is to be understood that the present invention is capable of use in various other combinations and environments and is capable of changes or modifications within the scope of the inventive concept as expressed herein. Embodiments of the invention may be used with software routines other than messaging and e-commerce, and these are only exemplary implementations.

Different embodiments of the invention may be adaptable for different and specialized purposes. Embodiments of the invention may include implementation of a system on a shared server or in a hardened appliance and may be adapted, e.g., to permit the implementation of the invention across servers on the Internet or in a large heterogeneous environment, such as a private cloud.

It should also be understood that software and/or hardware consistent with embodiments of the invention can be employed, e.g., at endpoint nodes of a network, centrally within a network, as part of a network node, between a standalone pair of interconnected devices not networked to other devices, at a user's end, at the server end, or at any other location within a scheme of interconnected devices.

It should be understood that appropriate hardware, software, or a combination of both hardware and software is provided to effect the processing described above, in the various embodiments of the invention. It should further be recognized that a particular embodiment might support one or more of the modes of operation described herein.

It should be understood that various changes in the details, materials, and arrangements of the parts which have been described and illustrated in order to explain the nature of embodiments of the invention may be made by those skilled in the art without departing from the scope of the disclosure. For example, it should be understood that the inventive concepts of embodiments of the invention may be applied not only in systems and devices for enhancing search-bar functionality, but also in other applications for which embodiments of the invention may have utility.

Embodiments of the present invention can take the form of methods and apparatuses for practicing those methods. Such embodiments can also take the form of program code embodied in tangible media, such as magnetic recording media, optical recording media, solid state memory, floppy diskettes, CD-ROMs, hard drives, or any other non-transitory machine-readable storage medium, wherein, when the program code is loaded into and executed by a machine, such as a computer, the machine becomes an apparatus for practicing embodiments of the invention. Embodiments of the invention can also be embodied in the form of program code, for example, stored in a non-transitory machine-readable storage medium including being loaded into and/or executed by a machine, wherein, when the program code is loaded into and executed by a machine, such as a computer, the machine becomes an apparatus for practicing embodiments of the invention. When implemented on a general-purpose processor or custom specific processors, the program code segments combine with the processor to provide a unique device that operates analogously to specific logic circuits. The program code may also be implemented in a cloud computing infrastructure or other distributed computing arrangement that involves a large number of computers connected through a communication network such as the Internet, e.g., a software as a service (SaaS) infrastructure, a platform as a service (PaaS) infrastructure, or an infrastructure as a service (IaaS) infrastructure, and may be implemented in a “Big Data” infrastructures, i.e., collections of data sets too large for traditional analytical methods, such as technology segments that employ platforms such as Apache™ Hadoop, Apache™ Storm, Apache™ Tez, the High Performance Computing Cluster (HPCC) Systems Platform, or the like.

It will be appreciated by those skilled in the art that although the functional components of the exemplary embodiments of the system described herein may be embodied as one or more distributed computer program processes, data structures, dictionaries and/or other stored data on one or more conventional general-purpose computers (e.g., IBM-compatible, Apple Macintosh, and/or RISC microprocessor-based computers), mainframes, minicomputers, conventional telecommunications (e.g., modem, T1, fiber-optic line, DSL, satellite and/or ISDN communications), memory storage means (e.g., RAM, ROM) and storage devices (e.g., computer-readable memory, disk array, direct access storage) networked together by conventional network hardware and software (e.g., LAN/WAN network backbone systems and/or Internet), other types of computers and network resources may be used without departing from the present invention. One or more networks discussed herein may be a local area network, wide area network, internet, intranet, extranet, proprietary network, virtual private network, a TCP/IP-based network, a wireless network (e.g., IEEE 802.11 or Bluetooth), an e-mail based network of e-mail transmitters and receivers, a modem-based, cellular, or mobile telephonic network, an interactive telephonic network accessible to users by telephone, or a combination of one or more of the foregoing.

Embodiments of the invention as described herein may be implemented in one or more computers residing on a network transaction server system, and input/output access to embodiments of the invention may include appropriate hardware and software (e.g., personal and/or mainframe computers provisioned with Internet wide area network communications hardware and software (e.g., CQI-based, FTP, Netscape Navigator™, Mozilla Firefox™, Microsoft Internet Explorer™, Google Chrome™, or Apple Safari™ HTML Internet-browser software, and/or direct real-time or near-real-time TCP/IP interfaces accessing real-time TCP/IP sockets) for permitting human users to send and receive data, or to allow unattended execution of various operations of embodiments of the invention, in real-time and/or batch-type transactions. Likewise, a system consistent with the present invention may include one or more remote Internet-based servers accessible through conventional communications channels (e.g., conventional telecommunications, broadband communications, wireless communications) using conventional browser software (e.g., Netscape Navigator™, Mozilla Firefox™, Microsoft Internet Explorer™, Google Chrome™, or Apple Safari™). Thus, embodiments of the present invention may be appropriately adapted to include such communication functionality and Internet browsing ability. Additionally, those skilled in the art will recognize that the various components of the server system of the present invention may be remote from one another, and may further include appropriate communications hardware/software and/or LAN/WAN hardware and/or software to accomplish the functionality herein described.

Each of the functional components of embodiments of the present invention may be embodied as one or more distributed computer-program processes running on one or more conventional general purpose computers networked together by conventional networking hardware and software. Each of these functional components may be embodied by running distributed computer-program processes (e.g., generated using “full-scale” relational database engines such as IBM DB2™, Microsoft SQL Server™, Sybase SQL Server™, or Oracle 10g™ database managers, and/or a JDBC interface to link to such databases) on networked computer systems (e.g., including mainframe and/or symmetrically or massively-parallel computing systems such as the IBM SB2™ or HP 9000™ computer systems) including appropriate mass storage, networking, and other hardware and software for permitting these functional components to achieve the stated function. These computer systems may be geographically distributed and connected together via appropriate wide- and local-area network hardware and software. In one embodiment, data stored in the database or other program data may be made accessible to the user via standard SQL queries for analysis and reporting purposes.

Primary elements of embodiments of the invention may be server-based and may reside on hardware supporting an operating system such as Linux, Microsoft Windows NT/2000™ or UNIX.

Components of a system consistent with embodiments of the invention may include mobile and non-mobile devices. Mobile devices that may be employed in embodiments of the present invention include personal digital assistant (PDA) style computers, e.g., as manufactured by Apple Computer, Inc. of Cupertino, Calif., or Palm, Inc., of Santa Clara, Calif., and other computers running the Android, Symbian, RIM Blackberry, Palm webOS, or iPhone operating systems, Windows CE™ handheld computers, or other handheld computers (possibly including a wireless modem), as well as wireless, cellular, or mobile telephones (including GSM phones, J2ME and WAP-enabled phones, Internet-enabled phones and data-capable smart phones), one- and two-way paging and messaging devices, laptop computers, etc. Other telephonic network technologies that may be used as potential service channels in a system consistent with embodiments of the invention include 2.5G cellular network technologies such as GPRS and EDGE, as well as 3G technologies such as CDMA1xRTT and WCDMA2000, and 4G technologies. Although mobile devices may be used in embodiments of the invention, non-mobile communications devices are also contemplated by embodiments of the invention, including personal computers, Internet appliances, set-top boxes, landline telephones, etc. Clients may also include a PC that supports Apple Macintosh™, Microsoft Windows 95/98/NT/ME/CE/2000/XP/Vista/7/8™, a UNIX Motif workstation platform, Linux, or other computer capable of TCP/IP or other network-based interaction. In one embodiment, no software other than a web browser may be required on the client platform.

Alternatively, the aforesaid functional components may be embodied by a plurality of separate computer processes (e.g., generated via dBase™, Xbase™, MS Access™ or other “flat file” type database management systems or products) running on IBM-type, Intel Pentium™ or RISC microprocessor-based personal computers networked together via conventional networking hardware and software and including such other additional conventional hardware and software as may be necessary to permit these functional components to achieve the stated functionalities. In this alternative configuration, since such personal computers typically may be unable to run full-scale relational database engines of the types presented above, a non-relational flat file “table” (not shown) may be included in at least one of the networked personal computers to represent at least portions of data stored by a system according to embodiments of the present invention. These personal computers may run the Unix, Linux, Microsoft Windows NT/2000™ or Windows 95/98/NT/ME/CE/2000/XP/Vista/7/8™ operating systems. The aforesaid functional components of a system according to the invention may also include a combination of the above two configurations (e.g., by computer program processes running on a combination of personal computers, RISC systems, mainframes, symmetric or parallel computer systems, and/or other appropriate hardware and software, networked together via appropriate wide- and local-area network hardware and software).

A system according to embodiments of the present invention may also be part of a larger system including multi-database or multi-computer systems or “warehouses” wherein other data types, processing systems (e.g., transaction, financial, administrative, statistical, data extracting and auditing, data transmission/reception, and/or accounting support and service systems), and/or storage methodologies may be used in conjunction with those of the present invention to achieve additional functionality.

In one embodiment, source code may be written in an object-oriented programming language using relational databases. Such an embodiment may include the use of programming languages such as C++ and toolsets such as Microsoft's .Net™ framework. Other programming languages that may be used in constructing a system according to embodiments of the present invention include Java, HTML, Perl, UNIX shell scripting, assembly language, Fortran, Pascal, Visual Basic, and QuickBasic. Those skilled in the art will recognize that embodiments of the present invention may be implemented in hardware, software, or a combination of hardware and software.

Accordingly, the terms “server,” “computer,” and “system,” as used herein, should be understood to mean a combination of hardware and software components including at least one machine having a processor with appropriate instructions for controlling the processor. The singular terms “server,” “computer,” and “system” should also be understood to refer to multiple hardware devices acting in concert with one another, e.g., multiple personal computers in a network; one or more personal computers in conjunction with one or more other devices, such as a router, hub, packet-inspection appliance, or firewall; a residential gateway coupled with a set-top box and a television; a network server coupled to a PC; a mobile phone coupled to a wireless hub; and the like. The term “processor” should be construed to include multiple processors operating in concert with one another.

It should also be appreciated from the outset that one or more of the functional components may alternatively be constructed out of custom, dedicated electronic hardware and/or software, without departing from the present invention. Thus, embodiments of the invention are intended to cover all such alternatives, modifications, and equivalents as may be included within the spirit and broad scope of the disclosure.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments of the present invention.

It will be further understood that various changes in the details, materials, and arrangements of the parts which have been described and illustrated in order to explain the nature of this disclosure may be made by those skilled in the art without departing from the scope of the disclosure as expressed in the following claims.

The embodiments covered by the claims in this application are limited to embodiments that (1) are enabled by this specification and (2) correspond to statutory subject matter. Non-enabled embodiments and embodiments that correspond to non-statutory subject matter are explicitly disclaimed even if they fall within the scope of the claims.

What is claimed is:

1. A computer-implemented method for extending functionality of a browser text-entry field, the method comprising:
(a) the computer monitoring the browser text-entry field to detect a predetermined initial combination of characters in a query entered by a user; and
(b) if the predetermined initial combination of characters is detected in the query, then:
(i) the computer detecting the remaining characters in the query; and
(ii) the computer providing, to a software routine, the remaining characters in the query.

2. The method of claim 1, wherein step (a) is performed by a browser add-on or extension.

3. The method of claim 1, wherein step (a) is performed by the browser.

4. The method of claim 1, wherein:
following the predetermined initial combination of characters, the remaining characters in the query comprise: (i) a word, and (ii) a set of characters following the word; and
the computer is adapted to provide the remaining characters in the query to the software routine selected based on identification of the predetermined initial combination of characters.

5. The method of claim 4, wherein:
the word identifies a user or user account;
the set of characters following the word is a message to send to the identified user or user account; and
the software routine is a messaging routine that sends the message to the identified user or user account using a communications method predetermined by the identified user or user account.

6. The method of claim 5, wherein the communications method is a social network messaging platform.

7. The method of claim 5, wherein the communications method is e-mail.

8. The method of claim 5, wherein the communications method is SMS or a multimedia message.

9. The method of claim 5, wherein the communications method is telephone.

10. The method of claim 4, wherein:
the word identifies a merchant or merchant account;
the set of characters following the word includes identification of one or more offerings to purchase from the identified merchant or merchant account; and
the software routine is an electronic commerce routine that sends the identification of one or more offerings to the identified merchant or merchant account using a merchant-specified communications method.

11. The method of claim 5, wherein the communications method is a social network messaging platform.

12. The method of claim 5, wherein the communications method is e-mail.

13. The method of claim 5, wherein the communications method is SMS or a multimedia message.

14. The method of claim 5, wherein the communications method is telephone.

15. A system for extending functionality of a browser text-entry field, the system comprising:
a processor adapted to:
(a) monitor the browser text-entry field to detect a predetermined initial combination of characters in a query entered by a user; and
(b) if the predetermined initial combination of characters is detected in the query, then:
(i) detect the remaining characters in the query; and
(ii) provide, to the software routine, the remaining characters in the query.

16. The system of claim 15, wherein step (a) is performed by a browser add-on or extension.

17. The system of claim 15, wherein step (a) is performed by the browser.

18. The system of claim 15, wherein, following the predetermined initial combination of characters, the remaining characters in the query comprise: (i) a word, and (ii) a set of characters following the word; and
the computer is adapted to provide the remaining characters in the query to a software routine selected based on identification of the predetermined initial combination of characters.

19. The system of claim 18, wherein:
the word identifies a user or user account;
the set of characters following the word is a message to send to the identified user or user account; and
the software routine is a messaging routine that sends the message to the identified user or user account using a communications method predetermined by the identified user or user account.

20. The system of claim 19, wherein the communications method is a social network messaging platform.

21. The system of claim 19, wherein the communications method is e-mail.

22. The system of claim 19, wherein the communications method is SMS or a multimedia message.

23. The system of claim 19, wherein the communications method is telephone.

24. The system of claim 18, wherein:
the word identifies a merchant or merchant account;
the set of characters following the word includes identification of one or more offerings to purchase from the identified merchant or merchant account; and
the software routine is an electronic commerce routine that sends the identification of one or more offerings to the identified merchant or merchant account using a merchant-specified communications method.

25. The system of claim 24, wherein the communications method is a social network messaging platform.

26. The system of claim 24, wherein the communications method is e-mail.

27. The system of claim 24, wherein the communications method is SMS or a multimedia message.

28. The system of claim 25, wherein the communications method is telephone.
